(19) United States
(12) Patent Application Publication
(10) Pub. No.: US 2025/0392731 A1
(43) Pub. Date: Dec. 25, 2025

(54) TECHNIQUES FOR SCALING REGIONS OF INTEREST

(71) Applicant: NETFLIX, INC., Los Gatos, CA (US)

(72) Inventors: Joel SOLE ROJALS, San Diego, CA (US); Zhi LI, Mountain View, CA (US)

(21) Appl. No.: 19/030,709

(22) Filed: Jan. 17, 2025

Related U.S. Application Data
(60) Provisional application No. 63/662,860, filed on Jun. 21, 2024.

(51) Int. Cl. H04N 19/167; G06T 5/50; G06V 10/25; H04N 19/30; H04N 19/59

(52) U.S. Cl. CPC H04N 19/167; G06T 5/50; G06V 10/25; H04N 19/30; H04N 19/59; G06T 2207/20221

(57) ABSTRACT

In various embodiments, a computer-implemented method for generating enhanced frames of media data includes decoding a first video frame included in video data associated with a media title, decoding a first portion included in the video data, wherein the first portion includes less data than the first video frame, extracting first position data corresponding to the first portion from header information included in the video data, combining the first video frame and the first portion based on the first position data to generate a first enhanced video frame.

### CROSS-REFERENCE TO RELATED APPLICATIONS

This application claims the benefit of U.S. Provisional Application titled “TECHNIQUES FOR SCALING REGIONS OF INTEREST,” filed on Jun. 21, 2024, and having Ser. No. 63/662,860. The subject matter of this related application is hereby incorporated herein by reference.

### BACKGROUND

### Field of the Various Embodiments

Embodiments of the present disclosure relate generally to computer science and video processing and streaming media technologies and, more specifically, to techniques for scaling regions of interest.

### Description of the Related Art

A modern streaming service streams audio and video data associated with media titles to endpoint devices across a network. The video data is typically encoded at a variety of different frame rates and/or resolutions. During a streaming session, a given endpoint device can request video data with a specific frame rate and/or resolution that depends on the currently available network bandwidth. For example, an endpoint device with plentiful network bandwidth could request video data with a higher frame rate and/or a higher resolution, while an endpoint device with limited network bandwidth could request video data with a lower frame rate and/or lower resolution. The particular combination of frame rate and resolution at which a given endpoint device streams video data is typically referred to as the “operating point” of the endpoint device. Endpoint devices can transition dynamically between different operating points during streaming in response to changes in available network bandwidth and other factors.

Video data associated with a given media title can be encoded into different layers that correspond to specific operating points. These layers typically include a base layer that corresponds to the lowest available operating point and one or more enhancement layers that correspond to one or more progressively higher operating points. When an endpoint device operates at the lowest available operating point, the endpoint device can decode the base layer and then output video frames at the lowest available frame rate and lowest available resolution. When the endpoint device operates at a higher operating point, the endpoint device can decode the base layer as well as an enhancement layer that corresponds to a higher frame rate and/or higher resolution. The endpoint device then combines the decoded base layer and the decoded enhancement layer to generate video frames having a higher frame rate and/or higher resolution. In this manner, enhancement layers can be used to increase the frame rate and/or resolution associated with a given base layer.

An enhancement layer that is used to increase the frame rate of a given base layer typically includes additional video frames that can be interspersed with existing video frames associated with the base layer. An enhancement layer that is used to increase the resolution of a given base layer typically includes additional pixel or sample data that can be combined with the existing video frames associated with the base layer. An enhancement layer that is used to increase both the frame rate and the resolution of a given base layer typically includes both additional video frames that are interspersed with the existing video frames associated with the base layer and additional pixel or sample data that is combined with the existing video frames associated with the base layer. Video frames included in enhancement layers typically have the same or larger frame size than the video frames included in the corresponding base layer.

One drawback of the above approach is that the video frames included in a given enhancement layer are not always intended to provide enhancements to all portions of the video frames included in the corresponding base layer. However, in such situations, the video frames included in the enhancement layer still need to have the full frame size associated with the video frames included in the base layer. Consequently, enhancement layers oftentimes include a substantial amount of data that is not needed to generate the different video frames associated with elevated operating points. In some instances, this additional data in the enhancement layers can unnecessarily increase the overall bitrates used when streaming media titles to given endpoint devices. Increasing the bitrate unnecessarily consumes additional network bandwidth and can slow down the decoder included within a given endpoint device, which can introduce delays during a streaming session. Increasing the streaming bitrate unnecessarily also can cause the decoder within a given endpoint device to operate unnecessarily at higher codec levels (e.g., HEVC or AV1 level), which can cause the endpoint device to consume additional power. Further, certain endpoint devices may not provide hardware support for higher codec levels.

As the foregoing illustrates, what is needed in the art are more effective techniques for streaming media data to endpoint devices during streaming sessions.

### SUMMARY

In various embodiments, a computer-implemented method for generating enhanced frames of media data includes decoding a first video frame included in video data associated with a media title, decoding a first portion included in the video data, wherein the first portion includes less data than the first video frame, extracting first position data corresponding to the first portion from header information (or similar signaling mechanism) included in the video data, combining the first video frame and the first portion based on the first position data to generate a first enhanced video frame.

At least one technical advantage of the disclosed techniques relative to the prior art is that the disclosed techniques enable enhancement layers associated with media titles to have smaller sizes for given operating points relative to what can be achieved using conventional approaches. Accordingly, with the disclosed techniques, an endpoint device can stream a media title at a lower bitrate for a given operating point, thereby conserving network bandwidth and allowing the decoder within the endpoint device to operate without introducing substantial delays. Further, the disclosed techniques allow the decoder to operate at a lower level relative to what can be achieved using conventional techniques. Thus, the disclosed techniques enable endpoint devices to conserve power and facilitate streaming sessions for endpoint devices that have limited hardware capabilities. These technical advantages provide one or more technical advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments; and

FIG. 4 is a more detailed block diagram of the endpoint device of FIG. 1, according to various embodiments;

FIG. 5 illustrates how the content server of FIG. 1 distributes localized video data that includes different regions of interest to different geographical areas, according to various embodiments;

FIG. 6A is an exemplary header corresponding to a region of interest enhancement layer, according to various embodiments;

FIG. 6B illustrates how a region of interest enhancement layer is incorporated into video frame, according to various embodiments;

FIG. 7A illustrates how sequential region of interest enhancement layers are incorporated into sequential video frames, according to various embodiments;

FIG. 7B illustrates how geographically localized region of interest enhancement layers are incorporated into different video frames, according to various embodiments; and

FIG. 8 is a flow diagram of method steps for generating a localized video frame that includes a region of interest enhancement layer, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

A modern streaming service streams audio and video data to endpoint devices that is typically encoded at a variety of different frame rates and/or resolutions. A given endpoint device can request video data with a specific frame rate and/or resolution that depends on the currently available network bandwidth. The particular combination of frame rate and resolution at which a given endpoint device streams video data is typically referred to as the “operating point” of the endpoint device. Endpoint devices can transition dynamically between different operating points during streaming in response to various factors.

Video data associated with a given media title can be encoded into different layers that correspond to specific operating points. These layers typically include a base layer that corresponds to the lowest available operating point and one or more enhancement layers that correspond to one or more progressively higher operating points. When an endpoint device operates at the lowest available operating point, the endpoint device can decode the base layer and then output video frames at the lowest available frame rate and lowest available resolution. When the endpoint device operates at a higher operating point, the endpoint device can decode the base layer as well as an enhancement layer that corresponds to a higher frame rate and/or higher resolution. The endpoint device then combines the decoded base layer and the decoded enhancement layer to generate video frames having a higher frame rate and/or higher resolution. In this manner, enhancement layers can be used to increase the frame rate and/or resolution associated with a given base layer.

One drawback of the above approach is that the video frames included in a given enhancement layer cannot provide enhancements to just specific portions of the video frames included in the corresponding base layer. In such situations, the video frames included in the enhancement layer need to have the full frame size associated with the video frames included in the base layer. Consequently, enhancement layers oftentimes include a substantial amount of data that is not needed to generate the different video frames associated with elevated operating points. In some instances, this additional data in the enhancement layers can unnecessarily increase the overall bitrates used when streaming media titles to given endpoint devices. Increasing the bitrate unnecessarily consumes additional network bandwidth and can slow down the decoder included within a given endpoint device, which can introduce delays during a streaming session. Increasing the streaming bitrate unnecessarily also can cause the decoder within a given endpoint device to operate unnecessarily at higher levels. Certain endpoint devices may not provide hardware support for higher levels.

To address these issues, an encoder generates video data that includes a base layer and a region of interest enhancement layer. The region of interest enhancement layer describes one or more “regions of interest” that provide enhancements to specific portions of video frames included in the base layer. The region of interest enhancement layer has a smaller size than the video frames included in the base layer and therefore may include less data compared to conventional enhancement layers that have a full frame size. An endpoint device that streams the video data includes a decoder that decodes the base layer and the region of interest enhancement layer. The decoder parses a header associated with the video data to extract position and dimension data associated with the region of interest. The decoder then combines the base layer with the region of interest enhancement layer, based on the position and dimension data, to generate an enhanced video frame that includes the region of interest. The encoder can also generate different versions of the video data that include different region of interest enhancement layers. The different versions of the video data can be distributed to endpoint devices that reside in different geographical areas, thereby allowing media titles to be customized with geographically-aware regions of interest.

At least one technical advantage of the disclosed techniques relative to the prior art is that the disclosed techniques enable enhancement layers associated with media titles to have smaller sizes for given operating points relative to what can be achieved using conventional approaches. Accordingly, with the disclosed techniques, an endpoint device can stream a media title at a lower bitrate for a given operating point, thereby conserving network bandwidth and allowing the decoder within the endpoint device to operate without introducing substantial delays. Further, the disclosed techniques allow the decoder to operate at a lower codec level relative to what can be achieved using conventional techniques. Thus, the disclosed techniques allow endpoint devices to enable streaming sessions for endpoint devices that have limited hardware capabilities. These technical advantages provide one or more technical advancements over prior art approaches.

### System Overview

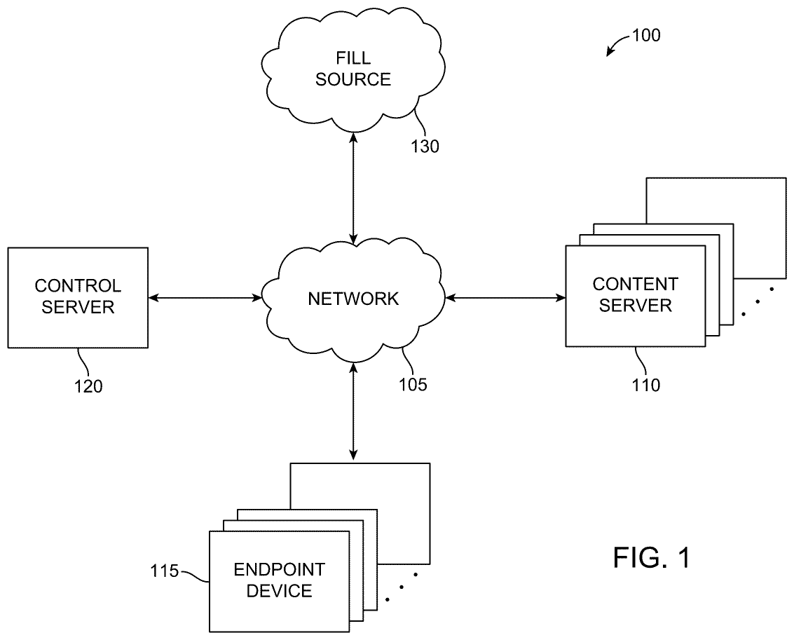

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

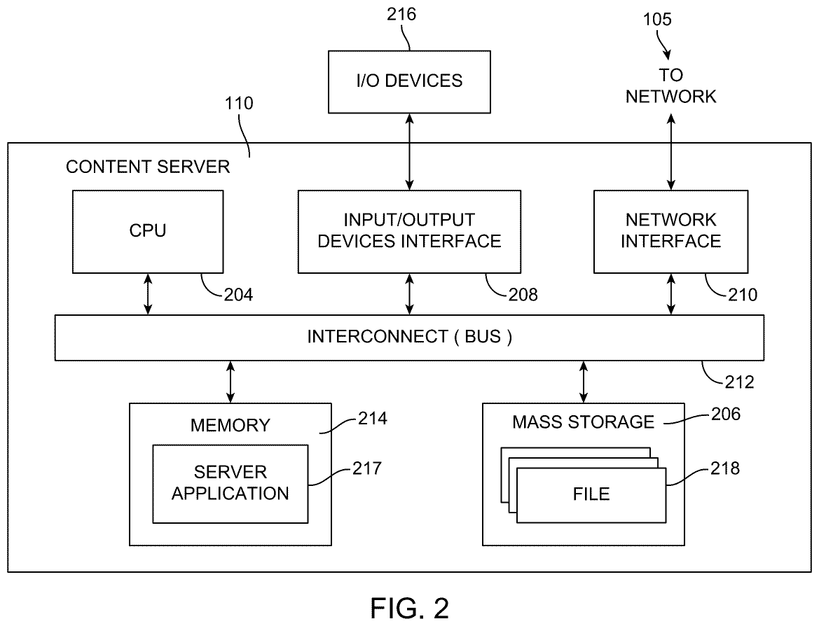

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

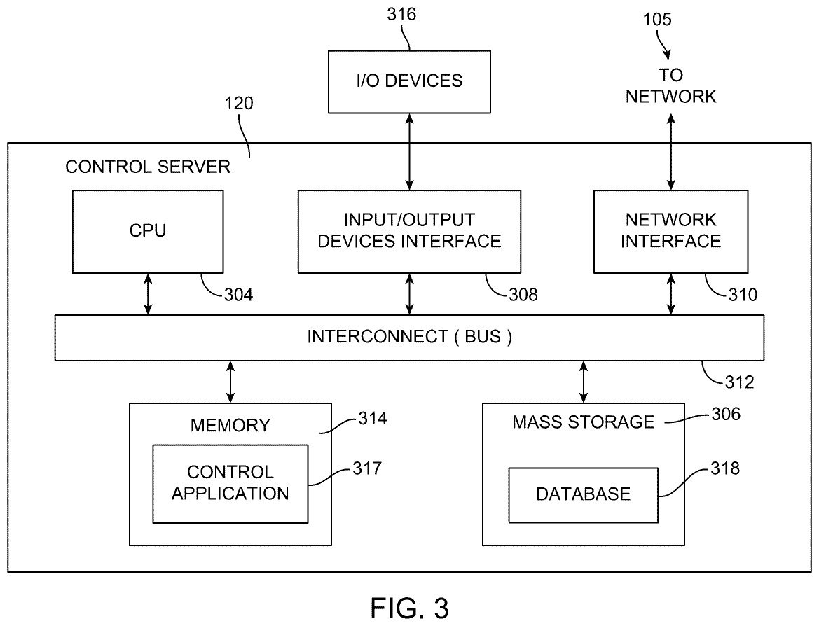

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

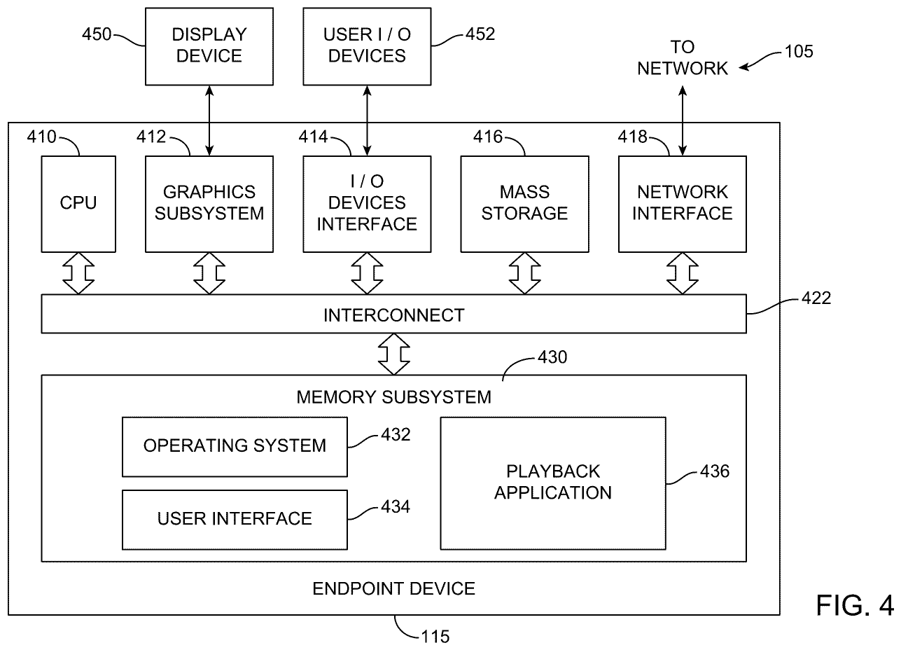

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoder that decodes compressed content prior to display via display device 450.

### Scaling Regions of Interest

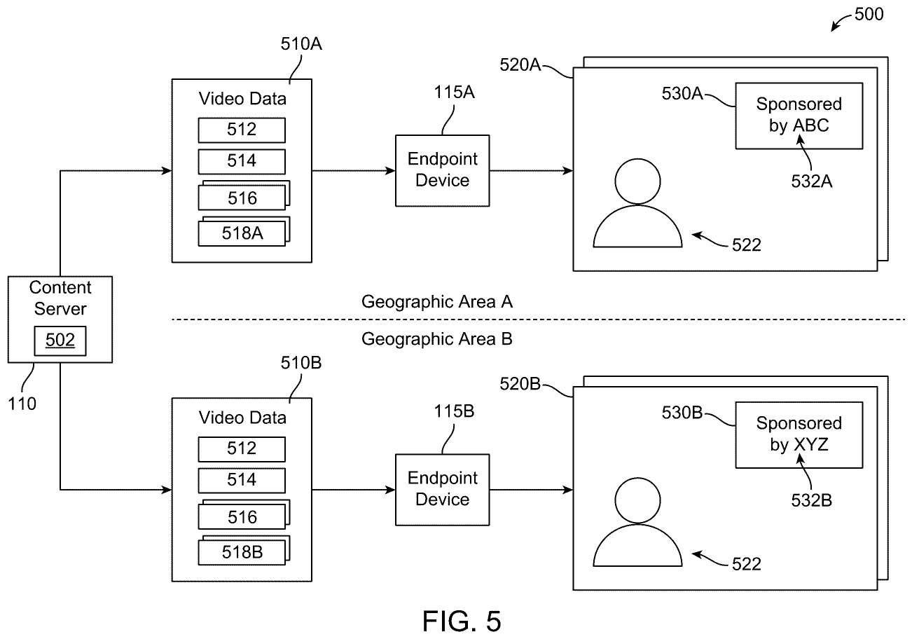

FIG. 5 illustrates how the content server of FIG. 1 distributes localized video data that includes different regions of interest to different geographical areas, according to various embodiments. As shown, a distribution pipeline 500 includes content server 110 and endpoint devices 115A and 115B. Content server 110 includes an encoder 502. Encoder 502 generates video data 510A and 510B via an encoding process, and content server 110 then transmits video data 510A and 510B to endpoint devices 115A and 115B, respectively. Endpoint device 115A resides in geographic area A, while endpoint device 115B resides in geographic area B. Video data 510A and 510B represent different versions of the video portion of a given media title that are customized for geographic regions A and B. Based on video data 510A, endpoint device 115A generates a video frame 520A that includes primary content 522 as well as a region of interest 530A. Region of interest 530A includes customized content 532A. Similarly, based on video data 510B, endpoint device 115B generates a video frame 520B that includes primary content 522 as well as a region of interest 530B. Region of interest 530B includes customized content 532B. Regions of interest 530A and 530B can be configured to include different content that is relevant to the specific users in geographic areas A and B, respectively.

Video data 510A and video data 510B both include header 512, base layer 514, one or more enhancement layers 516. Base layer 514 includes frames of video data that have a specific frame rate and resolution corresponding to a baseline operating point. Base layer 514 can be decoded and used to generate frames of video data independently of enhancement layer(s) 516. A given enhancement layer 516 includes frames of video data that, when combined with the frames of video data included in base layer 514, increase the frame rate and/or the resolution associated with the baseline operating point. Accordingly, each enhancement layer 516 corresponds to a progressively higher operating point beyond the baseline operating point.

Video data 510A and video data 510B also include region of interest enhancement layers 518A and 518B, respectively. Region of interest enhancement layer 518A defines region of interest 530A, while region of interest enhancement layer 518B defines region of interest 530B. Region of interest enhancement layers 518A and 518B need not define an entire frame of video data, because regions of interest 530A and 530B are smaller than an entire frame of video data. In one embodiment, regions of interest 530 may include one or more blocks of pixels or samples that, collectively, have smaller dimensions than video frames 520. A given block of pixels or samples may further include at least one boundary that is aligned with a block boundary associated with a given video frame 520. In another embodiment, regions of interest 530 may be portions of video frames. Region of interest enhancement layers 518A and 518B can be decoded separately from base layer 514 in order to avoid coding interactions potentially caused by, for example and without limitation, a deblocking filter that crosses a boundary associated with a given region of interest enhancement layer 518.

In operation, endpoint device 115A is configured to decode base layer 514, enhancement layer(s) 516, and region of interest enhancement layer(s) 518A. Endpoint device 115A also parses header 512 in order to extract position and dimension data associated with region of interest enhancement layer 518A. Endpoint device 115A then generates video frame 520A based on base layer 514, enhancement layer(s) 516, region of interest enhancement layer(s) 518A, and the position and dimension data extracted from header 512. In doing so, endpoint device 115A overlays region of interest 530A onto video frame 520A according to the extracted position and dimension data. Similarly, endpoint device 115B is configured to decode base layer 514, enhancement layer(s) 516, and region of interest enhancement layer(s) 518B. Endpoint device 115B also parses header 512 in order to extract position and dimension data associated with region of interest enhancement layer 518B. Endpoint device 115B then generates video frame 520B based on base layer 514, enhancement layer(s) 516, region of interest enhancement layer(s) 518B, and the position and dimension data extracted from header 512. In doing so, endpoint device 115B overlays region of interest 530B onto video frame 520B according to the extracted position and dimension data.

In one embodiment, the position data extracted from header 512 may indicate a row and column offset for regions of interest 530A and 530B, and the dimension data extracted from header 512 may indicate a width and height associated with regions of interest 530A and 530B. In various other embodiments, the position and dimension data included in header 512 can be modified in order to scale regions of interest 530A and/or 530B. A given endpoint device 115 may be configured to decode pixels or samples associated with base layer 514 and then overlay those pixels or samples with other pixels or samples derived from a region of interest enhancement layer 518, according to various embodiments. In another embodiment, a given endpoint device 115 may be configured to decode pixels or samples associated with base layer 514 and then alpha blend those pixels or samples with other pixels or samples derived from a region of interest enhancement layer 518.

In operation, distribution pipeline 500 can efficiently transmit video data 510 to endpoint devices 115 using region of interest enhancement layers 518. In particular, because region of interest enhancement layers 518 define regions of interest 530 that are smaller than entire frames, video data 510 can be transmitted with a lower bitrate for a given operating point than is possible with conventional techniques. Furthermore, region of interest enhancement layers 518 can be customized for specific geographical locations. With this approach, video frames 520 can be generated to include additional content that is specifically relevant to a given user. Persons skilled in the art will understand how the techniques described herein can be implemented to generate video frames that are customized based on any set of factors beyond geographical location, including user preferences, a user profile, a viewing history associated with a user, and so forth, for example and without limitation.

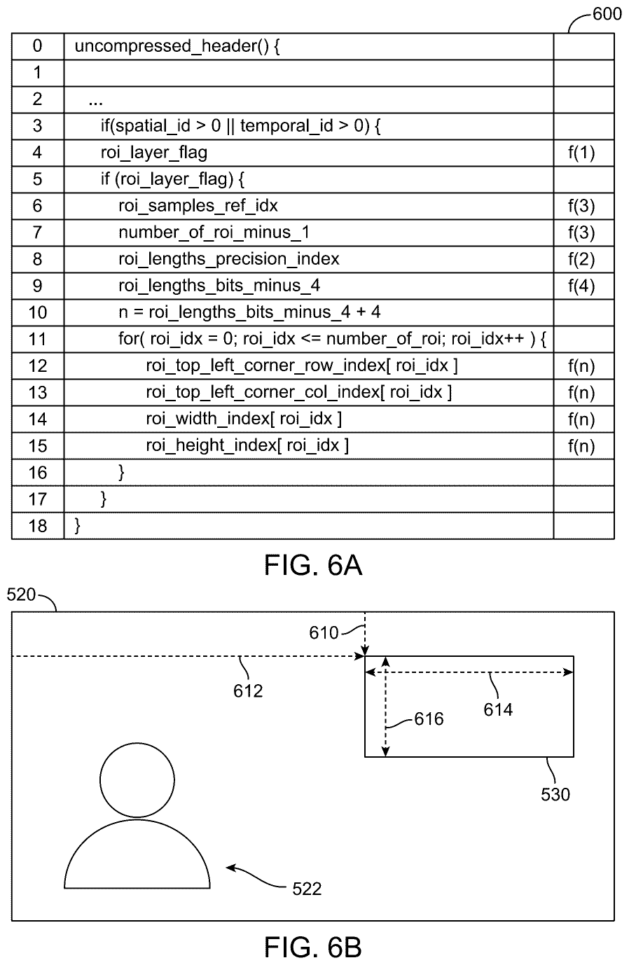

FIG. 6A is an exemplary header corresponding to a region of interest enhancement layer, according to various embodiments. In the example shown, header 600 is defined according to the Alliance for Open Media Video 1 (AV1) specification. In one embodiment, header 600 may be an open bitstream header unit (OBU) header or a frame header OBU. As shown, header 600 in includes lines 0 through 18. Line 0 indicates that header 600 is an uncompressed header. Line 3 conditionally allows lines 4-17 to execute when spatial_id is greater than 0. This value is zero when a spatial base layer is being processed. Either or both of spatial_id and/or temporal_id will be greater than zero when an enhancement layer is being processed. Line 4 reads the value roi_layer_flag from the bitstream, indicating that a region of interest enhancement layer is being processed. Line 5 conditionally executes lines 6-16 when roi_layer_flag is set. Lines 6-9 read variables roi_ref_samples_idx, number_of_roi_minus_1, roi_lengths_precision_index, and roi_lengths_bits_minus_4, respectively from the bitstream. Variable roi_ref_samples_idx indicates which reference frame includes pixels or samples to be used as the base layer for the region of interest enhancement layer. The variable number_of_roi_minus_1 indicates the number of regions of interest associated with the current frame, minus 1. The variable roi_lengths_precision_index indicates the precision with which the position and dimension data associated with a given region of interest is provided. In one embodiment, roi_lengths_precision_index may include an index into a table that includes a precision value expressed in luma samples. Table 1 sets forth an example mapping between roi_lengths_precision_index and precision values defined via roi_lengths_precision:

TABLE 1

| roi_lengths_precision_index | roi_lengths_precision |
|---|---|
| 0 | 4 |
| 1 | 8 |
| 2 | 16 |
| 3 | 32 |

The variable roi_lengths_bits_minus_4 indicates the number of bits used to signal the position and dimension data associated with each region of interest, minus 4. Line 10 computes the actual number of bits used to signal the position and dimension data. Line 11 iterates over lines 12-15 a number of times that depends on the number of regions of interest. Lines 12-15 define the position and dimension data associated with each region of interest. The arrays roi_top_left_corner_row_index and roi_top_left_col_index at lines 12 and 13, respectively, indicate position data for one or more regions of interest. These arrays can be indexed using roi_idx to provide the top-left corner row index and the top-left corner column index of a given region of interest. The arrays roi_width_index and roi_height_index at lines 14 and 15, respectively, indicate dimension data for one or more regions of interest. These arrays can be indexed using roi_idx to provide the width and height, respectively, of a given region of interest. Based on header 600, a given endpoint device 115 can generate a region of interest such as that described by way of example below in conjunction with FIG. 6B.

FIG. 6B illustrates how a region of interest enhancement layer is incorporated into a video frame, according to various embodiments. As shown, a video frame 520 includes primary content 522 and region of interest 530. The top-left corner of region of interest 530 is positioned based on vertical distance 610 and horizontal distance 612. Vertical distance 610 and horizontal distance 612 correspond to roi_top_left_corner_row_index and roi_top_left_corner_col_index, respectively, described above in conjunction with FIG. 6A. In addition, region of interest 530 is generated with width 614 and height 616. Width 614 and height 616 correspond to roi_width_index and roi_height_index, respectively, also described above in conjunction with FIG. 6A.

Referring generally to FIGS. 6A-6B, the disclosed techniques can be implemented to generate video frames that include one or more regions of interest. Persons skilled in the art will understand that header 600 and region of interest 530 are provided for exemplary purposes only and are not meant to limit the scope of the various embodiments. In various other embodiments, header 600 may be defined according to a different standard or defined using a different code structure. Further, region of interest 530 may be positioned and dimensioned using any technically feasible approach, and may have any technically feasible geometry. A given region of interest enhancement layer 518 may further include multiple overlapping regions of interest 530 defined via header 600 and indicated via roi_idx, where the value of roi_idx for each such region of interest 530 determines the precedence or z-index of the corresponding region of interest 530. Additionally, video data 510 can include multiple region of interest enhancement layers 518, each specifying one or more different regions of interest 530 that can be layered sequentially in order to provide different enhancements to video frames.

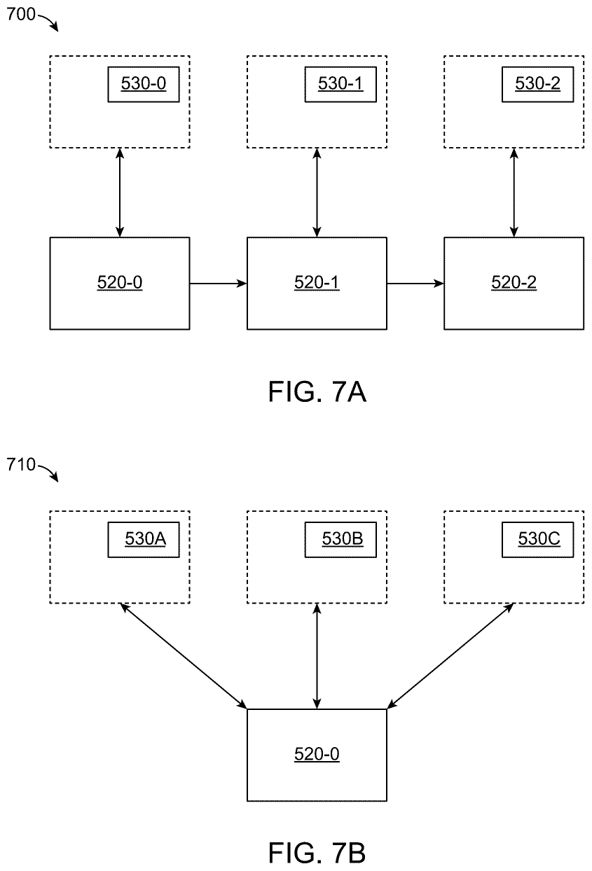

FIG. 7A illustrates how sequential region of interest enhancement layers are incorporated into sequential video frames, according to various embodiments. As shown, video data 700 includes video frames 520 derived from a base layer 514 and corresponding regions of interest 530 derived from a region of interest enhancement layer 518. During streaming, an endpoint device 115 decodes video frames 520 and regions of interest 530. Then, endpoint device 115 combines video frame 520-0 and region of interest 530-0, video frame 520-1 and region of interest 530-1, and video frame 520-2 and region of interest 520-2. In this manner, a given region of interest 530 can appear to change over time, and need not appear as a static image. Region of interest 530 has smaller dimensions than video frame 520 and can therefore be transmitted within a region of interest enhancement layer 518 with a lower bitrate than is possible with conventional enhancement layers.

FIG. 7B illustrates how geographically localized region of interest enhancement layers are incorporated into different video frames, according to various embodiments. As shown, video data 710 includes a video frame 520-0 derived from a base layer 514 and different versions of a region of interest 530 derived from different region of interest enhancement layers 518. During streaming, different endpoint devices 115 that reside in different geographic regions can decode video frame 520-0. Then, each of those different endpoint devices can decode a specific region of interest enhancement layer that defines one of regions of interest 530A, 530B, or 530C. Regions of interest 530A, 530B, and 530C could be individually customized for the different geographic areas where the different endpoint devices 115 reside, or customized based on any other technically feasible factor or set of factors. Each endpoint device 115 then generates an enhanced frame that includes video frame 520-0 and the relevant region of interest 530A, 530B, or 530C.

Referring generally to FIGS. 7A-7B, The disclosed techniques can be adapted to incorporate one or more regions of interest 530 into video frames 530. Those regions of interest may have an operating point corresponding to a given base layer 514, or may include additional data that modifies the operating point of the base layer 514 and/or one or more intervening enhancement layers 516. For example, and without limitation, a given region of interest 530 could be displayed with a frame rate that matches an underlying enhancement layer 516 that includes additional video frames that increase the frame rate of the base layer 514. Persons skilled in the art will understand that the disclosed techniques are sufficiently flexible to allow any technically feasible variation.

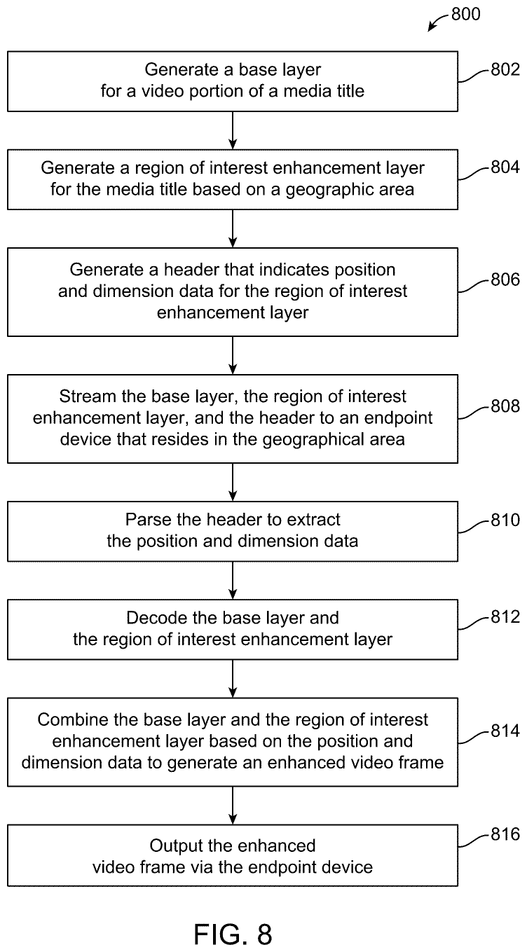

FIG. 8 is a flow diagram of method steps for generating a localized frame of video data that includes a region of interest enhancement layer, according to various embodiments. Although the method steps are described in conjunction with the systems of FIGS. 1-7B, persons skilled in the art will understand that any system configured to perform the method steps, in any order, is within the scope of the present invention.

As shown, a method 800 begins at step 802, where content server 110 generates a base layer 514 for a video portion of a media title. The base layer 514 includes frames of video data that have a specific frame rate and resolution corresponding to a baseline operating point. The base layer 514 can be decoded by an endpoint device 115 and used to generate frames of video data independently of any additional enhancement layers 516. One or more enhancement layers 516 can be combined with the base layer 514 in order to facilitate an increased operating point having a higher frame rate and/or a higher resolution.

At step 804, content server 110 generates a region of interest enhancement layer 518 for the media title based on a geographic area. The region of interest enhancement layer 518 defines a region of interest 530 corresponding to a given region. In the exemplary configuration shown in FIG. 5, region of interest enhancement layer 518A defines region of interest 530A for display in geographic area A, while region of interest enhancement layer 518B defines region of interest 530B for display in geographic area B. Region of interest enhancement layers 518 generally define regions of interest 530 that have smaller dimensions than an entire video frame, and therefore contribute fewer bits per second to the overall bitrate associated with streaming video data 510 compared to conventional streaming techniques.

At step 806, content server 110 generates a header 512 that indicates position and dimension data for the region of interest enhancement layer 518. The exemplary header 600 shown in FIG. 6A is defined according to the Alliance for Open Media Video 1 (AV1) specification, without limitation. In one embodiment, header 600 may be an open bitstream header unit (OBU) header or a frame header OBU. Header 512 generally includes position data and dimension data that can be used to project one or more potentially overlapping regions of interest 530 onto a video frame 520 associated with the base layer 512. In one embodiment, encoder 502 included in content server 110 performs steps 802, 804, and 806. In various other embodiments, encoder 502 may reside elsewhere in the network infrastructure 100 of FIG. 1.

At step 808, content server 110 streams the base layer 514, the region of interest enhancement layer 518, and the header 512 to an endpoint device 115 that resides in the geographical area. In one embodiment, the content server 110 may stream the base layer 514 within one compressed video stream and may stream the region of interest enhancement layer in another compressed video stream. Additionally, the content server 110 may transmit the header 512 within video data 510 in uncompressed form.

At step 810, the endpoint device 115 parses the header 512 to extract the position and dimension data. The position data parsed from the header 512 may indicate a row offset and a column offset within video frame 520 where region of interest 530 should be placed, in one embodiment. In another embodiment, the dimension data parsed from the header 512 may indicate a vertical size and a horizontal size with which the region of interest 530 should be scaled when projected onto video frame 520.

At step 812, the endpoint device 115 decodes the base layer 514 and the region of interest enhancement layer 518. The endpoint device 115 generally decodes the base layer 514 and the region of interest enhancement layer 518 separately and/or independently of one another. In one embodiment, the region of interest enhancement layer 518 may describe a region of interest 530 having block boundaries aligned with the block boundaries of video frame 520, thereby avoiding coding interactions potentially caused by deblocking filters.

At step 814, the endpoint device 115 combines the base layer 514 and the region of interest enhancement layer 518 based on the position and dimension data to generate an enhanced video frame. In doing so, the endpoint device 115 may overlay one or more blocks of pixels or samples derived from the region of interest enhancement layer 518 with one or more blocks of pixels or samples derived from the base layer 514. Persons skilled in the art will understand that endpoint device 115 can implement any technically feasible approach to combining and/or merging video data when performing step 814.

At step 816, the endpoint device 115 outputs the enhanced frame of video data via display device 450. The endpoint device 115 can repeat steps 820, 812, and 814 in order to generate additional enhanced video frames associated with the same region of interest 530, or to incorporate additional regions of interest into the enhanced video frame. The disclosed techniques provide a flexible and efficient approach for modifying and/or customizing video content based on various factors, including geographical area, among others.

To address these issues, an encoder generates video data that includes a base layer and a region of interest enhancement layer. The region of interest enhancement layer describes a “region of interest” that provides enhancements to a specific portion of video frames included in the base layer. The region of interest enhancement layer has a smaller size than the video frames included in the base layer. An endpoint device that streams the video data includes a decoder that decodes the base layer and the region of interest enhancement layer. The decoder parses a header associated with the video data to extract position and dimension data associated with the region of interest. The decoder then combines the base layer with the region of interest enhancement layer, based on the position and dimension data, to generate an enhanced video frame that includes the region of interest. The encoder can also generate different versions of the video data that include different region of interest enhancement layers. The different versions of the video data can be distributed to endpoint devices that reside in different geographical areas, thereby allowing media titles to be customized with geographically-aware regions of interest.

At least one technical advantage of the disclosed techniques relative to the prior art is that the disclosed techniques enable enhancement layers associated with media titles to have smaller sizes for given operating points relative to what can be achieved using conventional approaches. Accordingly, with the disclosed techniques, an endpoint device can stream a media title at a lower bitrate for a given operating point, thereby conserving network bandwidth and allowing the decoder within the endpoint device to operate without introducing substantial delays or compute. Further, the disclosed techniques may allow the decoder to operate at a lower level relative to what can be achieved using conventional techniques. Thus, the disclosed techniques enable endpoint devices to conserve power and facilitate streaming sessions for endpoint devices that have limited hardware capabilities. These technical advantages provide one or more technical advancements over prior art approaches.
1. Various embodiments include a computer-implemented method for generating enhanced frames of video data, the method comprising decoding a first video frame from video data associated with a media title, decoding a first video frame portion from the video data, wherein the first video frame portion has a smaller size than the first video frame, extracting first position data corresponding to the first video frame portion from a header included in the video data, and combining the first video frame with the first video frame portion based on the first position data to generate a first enhanced video frame.
2. The computer-implemented method of clause 1, wherein the first video frame corresponds to a base layer that has at least one of a lowest available frame rate or a lowest available resolution associated with the video data.
3. The computer-implemented method of any of clauses 1-2, wherein the first portion corresponds to an enhancement layer that has at least one of a first frame rate or a first resolution associated with the video data, wherein the first frame rate is greater than or equal to a lowest available frame rate, and the first resolution is greater than or equal to a lowest available resolution.
4. The computer-implemented method of any of clauses 1-3, wherein extracting the first position data from the header information comprises determining a row offset for the first portion within the first video frame based on the header information, and determine a column offset for the first portion within the first video frame based on the header information.
5. The computer-implemented method of any of clauses 1-4, wherein combining the first video frame and the first portion comprises projecting the first portion onto the first video frame using a row offset and a column offset indicated in the first position data.
6. The computer-implemented method of any of clauses 1-5, further comprising extracting first dimension data corresponding to the first portion from the header information, wherein the first video frame is combined with the first portion based further on the first dimension data.
7. The computer-implemented method of any of clauses 1-6, further comprising determining a vertical dimension for the first portion within the first video frame based on first dimension data included in the header information, determining a horizontal dimension for the first portion within the first video frame based on the first dimension data, and scaling the first portion according to the vertical dimension and the horizontal dimension to include in the enhancement layer.
8. The computer-implemented method of any of clauses 1-7, further comprising decoding a second portion included in the video data, wherein the second portion also is smaller than the first video frame, extracting second position data corresponding to the second portion from the header information, combining the first enhanced video frame and the second portion based on the second position data to generate a second enhanced video frame.
9. The computer-implemented method of any of clauses 1-8, wherein the first portion is associated with a first geographical area in which the first endpoint device resides.
10. The computer-implemented method of any of clauses 1-9, wherein the header information comprises open bitstream header unit (OBU) header information associated with an Alliance for Open Media Video (AV1) specification.
11. Various embodiments include one or more non-transitory computer-readable media including instructions that, when executed by one or more processors, cause the one or more processors to generate enhanced frames of video data by performing the steps of decoding a first video frame from video data associated with a media title, decoding a first video frame portion from the video data, wherein the first video frame portion has a smaller size than the first video frame, extracting first position data corresponding to the first video frame portion from a header included in the video data, and combining the first video frame with the first video frame portion based on the first position data to generate a first enhanced video frame.
12. The one or more non-transitory computer-readable media of clause 11, wherein the first video frame corresponds to a base layer that has at least one of a lowest available frame rate or a lowest available resolution associated with the video data, and wherein the first portion corresponds to an enhancement layer that has at least one of a first frame rate or a first resolution associated with the video data, wherein the first frame rate is greater than or equal to the lowest available frame rate, and the first resolution is greater than or equal to the lowest available resolution.
13. The one or more non-transitory computer-readable media of any of clauses 11-12, wherein the step of extracting the first position data from the header information comprises determining a row offset for the first portion within the first video frame based on the header information, and determine a column offset for the first portion within the first video frame based on the header information, wherein combining the first video frame and the first portion comprises projecting the first portion onto the first video frame using the row offset and the column offset.
14. The one or more non-transitory computer-readable media of any of clauses 11-13, further comprising the step of extracting first dimension data corresponding to the first portion from the header information, wherein the first video frame is combined with the first portion based further on the first dimension data.
15. The one or more non-transitory computer-readable media of any of clauses 11-14, further comprising the steps of determining a vertical dimension for the first portion within the first video frame based on first dimension data included in the header information, determining a horizontal dimension for the first portion within the first video frame based on the first dimension data, and scaling the first portion according to the vertical dimension and the horizontal dimension to include in the enhancement layer.
16. The one or more non-transitory computer-readable media of any of clauses 11-15, further comprising the steps of decoding a second portion included in the video data, wherein the second portion also is smaller than the first video frame, extracting second position data corresponding to the second portion from the header information, combining the first enhanced video frame and the second portion based on the second position data to generate a second enhanced video frame.
17. The one or more non-transitory computer-readable media of any of clauses 11-16, wherein the header information comprises open bitstream header unit (OBU) header information associated with an Alliance for Open Media Video (AV1) specification.
18. The one or more non-transitory computer-readable media of any of clauses 11-17, wherein the first portion comprises one or more blocks of pixels or samples.
19. The one or more non-transitory computer-readable media of any of clauses 11-18, where the first portion includes a first boundary that is aligned with a first block boundary associated with the first video frame.
20. Various embodiments include a system comprising one or more memories storing instructions, and one or more processors coupled to the one or more memories that, when executing the instructions, perform the steps of decoding a first video frame from video data associated with a media title, decoding a first video frame portion from the video data, wherein the first video frame portion has a smaller size than the first video frame, extracting first position data corresponding to the first video frame portion from a header included in the video data, and combining the first video frame with the first video frame portion based on the first position data to generate a first enhanced video frame.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating enhanced frames of video data, the method comprising:
decoding a first video frame from video data associated with a media title;
decoding a first video frame portion from the video data, wherein the first video frame portion has a smaller size than the first video frame;
extracting first position data corresponding to the first video frame portion from a header included in the video data; and
combining the first video frame with the first video frame portion based on the first position data to generate a first enhanced video frame.

2. The computer-implemented method of claim 1, wherein the first video frame corresponds to a base layer that has at least one of a lowest available frame rate or a lowest available resolution associated with the video data.

3. The computer-implemented method of claim 1, wherein the first portion corresponds to an enhancement layer that has at least one of a first frame rate or a first resolution associated with the video data, wherein the first frame rate is greater than or equal to a lowest available frame rate, and the first resolution is greater than or equal to a lowest available resolution.

4. The computer-implemented method of claim 1, wherein extracting the first position data from the header information comprises:
determining a row offset for the first portion within the first video frame based on the header information; and
determine a column offset for the first portion within the first video frame based on the header information.

5. The computer-implemented method of claim 1, wherein combining the first video frame and the first portion comprises projecting the first portion onto the first video frame using a row offset and a column offset indicated in the first position data.

6. The computer-implemented method of claim 1, further comprising extracting first dimension data corresponding to the first portion from the header information, wherein the first video frame is combined with the first portion based further on the first dimension data.

7. The computer-implemented method of claim 1, further comprising:
determining a vertical dimension for the first portion within the first video frame based on first dimension data included in the header information;
determining a horizontal dimension for the first portion within the first video frame based on the first dimension data; and
scaling the first portion according to the vertical dimension and the horizontal dimension to include in the enhancement layer.

8. The computer-implemented method of claim 1, further comprising:
decoding a second portion included in the video data, wherein the second portion also is smaller than the first video frame;
extracting second position data corresponding to the second portion from the header information;
combining the first enhanced video frame and the second portion based on the second position data to generate a second enhanced video frame.

9. The computer-implemented method of claim 1, wherein the first portion is associated with a first geographical area in which the first endpoint device resides.

10. The computer-implemented method of claim 1, wherein the header information comprises open bitstream header unit (OBU) header information associated with an Alliance for Open Media Video (AV1) specification.

11. One or more non-transitory computer-readable media including instructions that, when executed by one or more processors, cause the one or more processors to generate enhanced frames of video data by performing the steps of:
decoding a first video frame from video data associated with a media title;
decoding a first video frame portion from the video data, wherein the first video frame portion has a smaller size than the first video frame;
extracting first position data corresponding to the first video frame portion from a header included in the video data; and
combining the first video frame with the first video frame portion based on the first position data to generate a first enhanced video frame.

12. The one or more non-transitory computer-readable media of claim 11, wherein the first video frame corresponds to a base layer that has at least one of a lowest available frame rate or a lowest available resolution associated with the video data, and wherein the first portion corresponds to an enhancement layer that has at least one of a first frame rate or a first resolution associated with the video data, wherein the first frame rate is greater than or equal to the lowest available frame rate, and the first resolution is greater than or equal to the lowest available resolution.

13. The one or more non-transitory computer-readable media of claim 11, wherein the step of extracting the first position data from the header information comprises:
determining a row offset for the first portion within the first video frame based on the header information; and
determine a column offset for the first portion within the first video frame based on the header information, wherein combining the first video frame and the first portion comprises projecting the first portion onto the first video frame using the row offset and the column offset.

14. The one or more non-transitory computer-readable media of claim 11, further comprising the step of extracting first dimension data corresponding to the first portion from the header information, wherein the first video frame is combined with the first portion based further on the first dimension data.

15. The one or more non-transitory computer-readable media of claim 11, further comprising the steps of:
determining a vertical dimension for the first portion within the first video frame based on first dimension data included in the header information;
determining a horizontal dimension for the first portion within the first video frame based on the first dimension data; and
scaling the first portion according to the vertical dimension and the horizontal dimension to include in the enhancement layer.

16. The one or more non-transitory computer-readable media of claim 11, further comprising the steps of:
decoding a second portion included in the video data, wherein the second portion also is smaller than the first video frame;
extracting second position data corresponding to the second portion from the header information;
combining the first enhanced video frame and the second portion based on the second position data to generate a second enhanced video frame.

17. The one or more non-transitory computer-readable media of claim 11, wherein the header information comprises open bitstream header unit (OBU) header information associated with an Alliance for Open Media Video (AV1) specification.

18. The one or more non-transitory computer-readable media of claim 11, wherein the first portion comprises one or more blocks of pixels or samples.

19. The one or more non-transitory computer-readable media of claim 11, where the first portion includes a first boundary that is aligned with a first block boundary associated with the first video frame.

20. A system comprising:
one or more memories storing instructions; and
one or more processors coupled to the one or more memories that, when executing the instructions, perform the steps of:
decoding a first video frame from video data associated with a media title,
decoding a first video frame portion from the video data, wherein the first video frame portion has a smaller size than the first video frame,
extracting first position data corresponding to the first video frame portion from a header included in the video data, and
combining the first video frame with the first video frame portion based on the first position data to generate a first enhanced video frame.
